(19) United States
(12) Patent Application Publication
(10) Pub. No.: US 2002/0189462 A1
(43) Pub. Date: Dec. 19, 2002

(54) Automatic cooking monitor, device, system and method which operate in accordance with the thermal equalization of a heated comestible

(76) Inventor: William Younger Guess, Baton Rouge, LA (US)

Correspondence Address: William Younger Guess, 1144 Parlange, Baton Rouge, LA, 70806, US

(21) Appl. No.: 10/109,478

(22) Filed: Mar. 27, 2002

Related U.S. Application Data
(60) Provisional application No. 60/279,261, filed on Mar. 28, 2001.

(51) Int. Cl. A23L 1/00; A47J 37/04

(52) U.S. Cl. 99/326; 99/334; 99/419; 99/421 H

(57) ABSTRACT

An automatic cooking monitor, control device and method are described which are able to cook a food item of any weight to an exact degree of doneness by either alerting a user to provide a substantially ambient temperature environment to a food item having been heated to a primary referenced internal temperature prior to final doneness; or by automatically and rapidly providing a reduced temperature environment in response to the food item's internal temperature then alerting the user to the conclusion of an adiabatic cycle as recognized by the monitor and control device.

### DESCRIPTION

### Drawing Figures

FIG. 1 shows a perspective view of an automatic wood pellet rotisserie carriage cooking device.

FIG. 2 shows an enlarged side elevation of the rotisserie carriage.

FIG. 3 shows an enlarged front elevation of the rotisserie carriage.

FIG. 4 shows a universal monitor/control device

FIG. 5 shows a block diagram schematic of the universal monitor/control device when used with the automatic wood pellet rotisserie carriage cooking device.

FIG. 6 shows a side elevation of an automatic rotisserie carriage device with electrically resistive heating elements and hold-till-cook refrigeration system.

FIG. 7 shows a block diagram schematic of the universal monitor/control device when used with the automatic rotisserie carriage device with electrically resistive heating elements and hold-till-cook refrigeration system.

FIG. 8 shows a perspective view of an automatic rotisserie carriage device with single front door and six rotisserie carriages.

FIG. 9 shows a block diagram schematic of the universal monitor/control device when used with the automatic rotisserie carriage device with single front door and six rotisserie carriages.

FIG. 10 shows a side elevation of an automatically actuated pivot type rotisserie cooking device

FIG. 11 shows a side elevation of the automatically actuated pivot type rotisserie cooking device with a thermister embedded skewer

FIG. 12 shows a perspective view of an automatically actuated pivot type rotisserie cooking device with two actuator assemblies.

FIG. 13 shows a block diagram schematic of the pivot type rotisserie cooking device when used with the universal monitor/control device

FIG. 14 shows a side elevation of an automatically shielded fireplace turntable cooking device.

FIG. 15 shows a top view of the rotisserie turntable with wheels of same shown using hidden lines, the shield and alternate actuator are shown using hidden lines.

FIG. 16 shows a block diagram schematic of the universal monitor/control device when used with the automatically shielded fireplace turntable cooking device.

FIG. 17 shows a perspective view of a chest of automatic cooking drawers.

FIG. 18 shows a front elevation of a chest of automatic cooking drawers.

FIG. 19 shows an enlarged sectional side view of automatic cooking drawer in a chill configuration, with the extended drawer shown using phantom lines.

FIG. 20 shows a sectional side view of an automatic cooking drawer in a cooking configuration.

FIG. 21 shows a sectional side view of an automatic cooking drawer in hot gas evacuation configuration.

FIG. 22 shows a rear elevation of a chest of automatic cooking drawers

FIG. 23 shows a block diagram schematic of the universal monitor/control device when used with the chest of automatic cooking drawers.

FIG. 24 shows a flow chart showing instructions to a cooking drawer after having been provided with a service time in excess on 1 hour prior to service.

| | |
|---|---|
| 30. | automatic rotisserie carriage cooking device |
| 32 | cooking section |
| 34. | cooking section floor |
| 36. | hopper section |
| 38. | transport section |
| 40. | power cord |
| 42. | control cable socket |
| 44a-c. | hinged doors |
| 46 | transport section base |
| 48. | actuated guillotine front door assembly |
| 50. | guillotine front door |
| 52. | slot |
| 54a and 54b | rails |
| 56 | rotisserie carriage assembly |
| 58. | food support receiver tube |
| 60. | motor |
| 62. | endless screw |
| 64. | retractable cable |
| 66. | cable support member |
| 68 | food support and drip pan assembly |
| 70 | drip pan support grate |
| 72. | food support hook |
| 74. | temperature probe assembly |
| 76. | solid combustible auger assembly |
| 78. | auger drive motor |
| 80. | solid combustible nozzle |
| 82. | solid combustible chute |
| 84. | electric heating element |
| 86. | fire grate |
| 88. | thermostat |
| 90. | ash drawer |
| 92. | hood |
| 94. | flu |
| 96. | hopper door |
| 98. | air vents |
| 100. | food support bearing |
| 102. | carriage frame |
| 104. | rotisserie motor |
| 106 | rotisserie motor output drive |
| 108 | pin |
| 110 | rotisserie motor drive shaft |
| 112. | motor insulator |
| 114. | bearing insulator |
| 116. | thermister + circuit contact screw |
| 118. | thermister + circuit contact screw |
| | on food support bearing carriages |
| 120. | thermister-circuit contact screw on |
| | rotisserie motor drive shaft |
| 122. | thermister-circuit contact screw on |
| | rotisserie motor housing |
| 124. | support pin |
| 126. | insulated coupling |
| 128. | bearing set screw |
| 130. | carriage drive nut |
| 134. | hinged slot cover |
| 136. | hinged slot cover |
| 138. | automatic rotisserie carriage cooking device with |
| | hold-till-cook refrigeration system |
| 140. | cold air valve |
| 142. | cold air valve actuator |
| 144. | refrigeration device |
| 146. | broiler element |
| 148. | roast/bake element |
| 150. | infrared thermometer |
| 152. | slot cover belt |
| 154. | slot cover belt roller |
| 156. | automatic rotisserie carriage device with single front door |
| | and six rotisserie carriages |
| 158a-f | indicator lights |
| 160. | automatically pivoting rotisserie |
| 162 | actuator assembly |
| 164 | fire box |
| 166 | actuator |
| 168. | rotisserie drive assembly |
| 170 | tubular support housing |
| 172. | rotisserie drive tube member |
| 174. | drip pan |
| 176. | drip pan juice valve |
| 178. | service shelf structure |
| 180. | heat shield |
| 182. | thermister |
| 184 | thermister skewer |
| 186. | food centering collar |
| 188. | springably hinged steak clasp |
| 190. | automatically shielded fireplace turntable |
| 192. | turntable assembly |
| 194. | turntable platform |
| 196. | turntable rotisserie assembly |
| 198. | heat shield |
| 200. | heat shield actuator |
| 202. | subfractional gear motor actuator |
| 204a, 204b, | heat shield rests |
| 206. | hinged temperature probe cable storage area cover |
| 208. | chest of automatic cooking drawers |
| 210. | drawer section housing |
| 212a | automatic cooking drawer 1 |
| 212b | automatic cooking drawer 2 |
| 212c | automatic cooking drawer 3 |
| 212d | automatic cooking drawer 4 |
| 212e | automatic cooking drawer 5 |
| 212f | automatic cooking drawer 6 |
| 212g | automatic cooking drawer 7 |
| 212h | automatic cooking drawer 8 |
| 212I | large automatic cooking drawer 9 |
| 214 | heat and hold drawer |
| 216 | plate warming drawer |
| 218. | refrigeration device housing |
| 220. | infrared warmer shelf |
| 222 | plate service area |
| 224 | infrared warmer |
| 226 | louver actuator |
| 228 | louver assembly |
| 230 | drawer electrical socket |
| 232 | drawer electrical plug |
| 234 | cold air valve |
| 236a-236j | cold air valve actuators |
| 238 | hot air valve |
| 240a-240i | hot air valve actuators |
| 242a-242j | exhaust plenums |
| 246 | exhaust flue |
| 248a-248d | cold air intake manifolds |
| 250 | magnet |
| 252 | proximity switch |
| 254 | universal control device and monitor |
| 256 | on/off switch |
| 258 | system type set key |
| 260 | system type display |
| 262 | individual device set key |
| 264 | individual device display |
| 266 | roast temperature set knob |
| 268 | roast temperature display |
| 270 | enter key |
| 272 | clear key |
| 274 | primary reference temperature set |
| 276 | primary reference temperature display |
| 278 | secondary reference temperature set knob |
| 280 | secondary reference temperature display |
| 282 | adiabatic cycle duration set knob |
| 284 | adiabatic cycle duration display |
| 286 | surface temperature set knob |
| 288 | surface temperature display |
| 290 | broil cycle duration set knob |
| 292 | broil cycle duration display |
| 294 | start key |
| 296 | electrical outlets for ancillary device |
| 298 | ancillary devices electrical outlets enable/disable switch |
| 300 | alarm |
| 302 | adiabatic cycle override/reset switch and display |
| 304 | phone jack |
| 306 | computer port |
| 308 | wireless device port |
| 310 | barcode reader |
| 312 | barcode reader on/off switch |
| 314 | power cable |
| 316 | control cable |
| 318 | controller control cable socket |
| 320 | controller control cable plug |
| 322 | device control cable plug |
| 324 | service time set switch |
| 326. | clock set key |
| 328 | service time set knob |
| 330 | service time set display |
| 332 | estimated total cook time set knob |
| 334 | estimated total cook time display |
| 336 | automatic roast set key |
| 338 | automatic broil then roast set key |
| 340 | broil by time/broil by surface temperature set switch |
| 342 | automatic broil untill primary reference |
| | temperature reached key |
| 344 | automatic braise key |
| 346 | temperature probe control device input socket |
| 348. | rotisserie motor override key |
| 350 | ancillary device start time key |
| 352. | ancillary device start time display |

### DESCRIPTION—FIGS. 1 to 5

One preferred embodiment of the present invention, the automatic rotisserie carriage cooking device 30, is illustrated in FIG. 1. A rectangular box-like cooking section 32 is superposed on and attached to a rectangular box-like hopper section 36. Mating to and attached to the uppermost sides and back of the cooking section is a transport section 38 that cantilevers over the front of the cooking section 32. These sections are preferably cast, welded and/or fastened using iron based material. A cooking section floor 34 is disposed between the cooking section and the hopper section. A transport section base 43 provides a floor for the transport section and a ceiling for the cooking section. Power and control electrical current is supplied by means of a power chord 40 and by means of a control cable socket 42 respectively. Though not shown appropriate relay or solid state driver devices would be used in conjunction with the electrical devices in the present invention as needed.

A slot 24 bisects the transport section base 19 from a point near the leading edge thereof to a point slightly past the midway point over the cooking section and allows for the travel of a food support receiver tube 58 therealong. The cooking section floor 34 and the transport section base 46 are layered and insulated sufficient to prevent excessive heat from passing respectively therethrough. Disposed at the back of the transport section 38 and mating to a corresponding opening in the transport section base 46 is a hood 92 which terminates into a flue 94 which jointly allow for the passage of hot gasses produced in the cooking section therethrough. Rails 54a and 54b are disposed along opposite sides of the slot 52 from the front of the cantilevered portion of the transport section 38 terminating at the hood 92. Releaseably hinged doors 44a, 44b, and 44c provide back and sides for the cooking section 32 and are preferably constructed of steel frames securing heat tolerant glass panels. An actuated guillotine front door assembly 48 is provided whereby a guillotine front door 50 is raised or lowered allowing for the ingress or egress of a food item passing thereover. The guillotine front door is also constructed of steel frames with a heat tolerant glass panel. All doors of the cooking device allow for visual inspection of food items cooked thereby. A rotisserie carriage assembly 56 is urged by means of a step motor 60 and an endless screw 62 used in combination with the rails 54a and 54b. Engaged and received by the food support receiver tube 58 are a drip pan assembly 68 with food grate 70 and a food support hook 72. The food support receiver tube is preferably composed of iron based material providing strength and electrical conductivity.

A solid combustible heating system of the type found in home heating pellet stoves and some cooking devices is disposed within the hopper section 36 and communicates into the cooking section 32, is comprised of an auger drive motor 78, an auger assembly 76, a solid combustible nozzle, a solid combustible slide or chute 82, and a fire grate 86. In use, pellets are deposited by means of the auger system, onto the fire grate. Combustion is initiated by means of an electrically resistive heating element 84 which is disposed onto the fire grate 86. A hopper door 96 is disposed on the front of the hopper section 36 and allow the loading of wood and/or charcoal pellets. A temperature probe assembly 74 connects to the food support receiver tube 58 at a point beneath the transport section base and the food support hook.

The rotisserie carriage assembly 56 as shown in FIG. 2 is comprised of a rectangular box-like carriage frame 102, the wheels of which support the frame and engage with rails 54a and 54b, an upper plate and a lower plate. The carriage frame is preferably constructed of iron based material. The food support receiver tube 58 is supported by means of a support pin 108 which in turn rests on a food support bearing 100. Sandwiched between the food support bearing 56 and the lower plate upper surface is a bearing insulator 114. Alternately the carriage frame may be composed of ceramic or other non-conductive material thereby negating the need for insulation. The food support receiver tube 58 is secured to the food support bearing 56 by means of a bearing set screw 128 in order to maintain rotational force when in operation. An insulator coupling 126 secures the food support receiver tube 58 to the rotisserie motor drive 110. A pin 108 secures the motor drive shaft 110 to the motor drive 106 of the rotisserie motor 104. The rotisserie motor is preferably a subfractional gear motor whose output drive 106 rotates at about 1.5 rpm when in operation. The rotisserie motor also preferably has a metal case that is electrically conductive through its output drive 106 by way of its internal bearing system. Sandwiched between the rotisserie motor 104 and the upper surface of the upper plate of the carriage frame 102 is a motor insulator 112. The lower plate and the upper plate and their respective insulators have holes in the center thereof, which allow for the passage of the food support tube 58 and the motor output drive 106 respectively therethrough. The food support tube 58 is preferably composed of iron based material and should be able to support a 100 pound load.

The temperature probe assembly 74 engages electrically with the food support tube 58 by means of a plug and socket, the female part of which is secured to the food support tube 58. Of the two electrical legs required for the thermister as carried by the temperature probe socket, one is attached to the food support shaft by means of a thermister circuit+contact screw 116. The other leg passes from the socket through the food support tube 58, through the insulated coupling 126, and is connected to the motor coupling shaft set screw 120. Rotational electrical continuity of the food support shaft contact is maintained through the inner ring of the food support bearing 100 and by means of the rollers through to the outer ring and bearing flange. An insulated wire connects this leg of the thermister from the thermister+circuit contact screw on the food support bearing to the retractable cable 64. Rotational electrical continuity of the thermister circuit contact screw on the motor coupling shaft 120 is maintained through the internal bearing of the rotisserie motor 104 and terminates by means of a thermister−circuit contact screw on the motor housing 122 and connects to the retractable cable. The retractable cable also provides electrical supply for the rotisserie motor. The rotisserie carriage assembly 56 is urged along the rails 54a and 54b by means of a carriage drive nut 130, the carriage drive nut receiver 132, and the endless screw 62 as rotated by the drive motor 60.

Referring to FIG. 3 hinged slot covers 134a and 134b provide a thermal barrier preventing excessive heat loss through slot 52. The slot covers are disposed between rails 54a and 54b and begin forward of and adjacent to a plane defined by the guillotine front door 50 and continue to a point approximately midway into the cooking section 32. These covers are urged open by the food support shaft by means of an upward turned lip on the leading edge thereof. This upward turned lip also appears at the distal end of the slot covers over the cooking section (not shown) and would provide the same function namely to lift the hinged slot covers 134a and 134b allowing for the passage of the food support receiver tube therebetween. Alternately actuators could lift and lower the slot covers avoiding friction wear into the food support receiver tube.

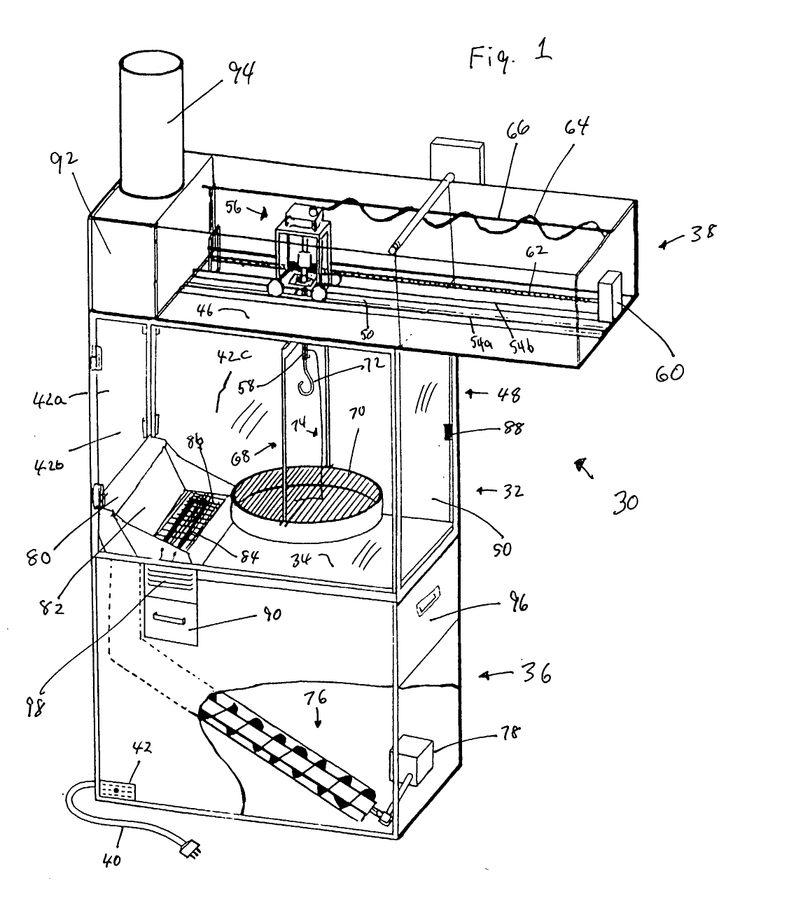

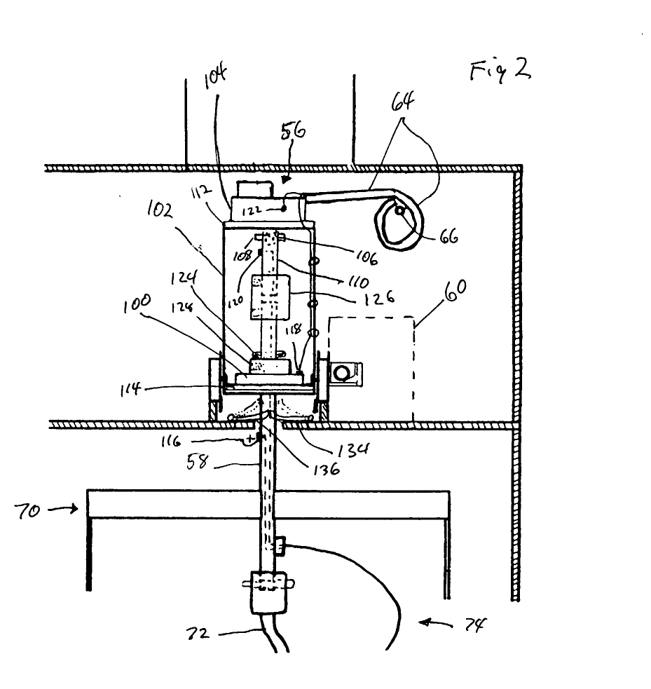

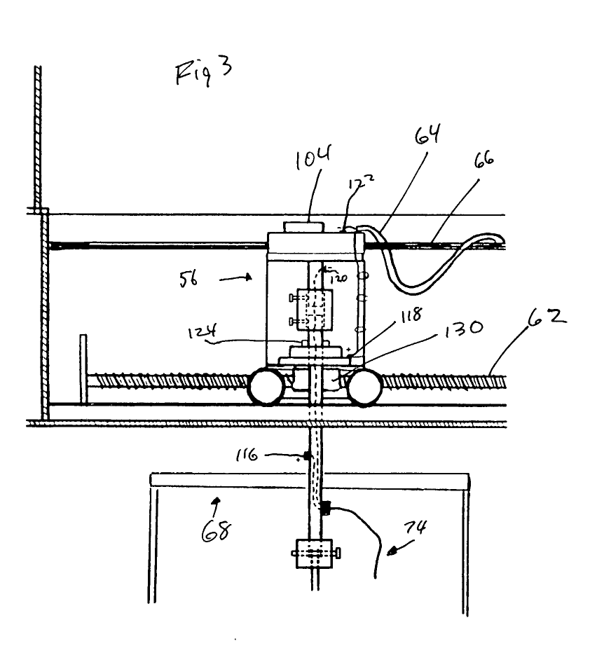

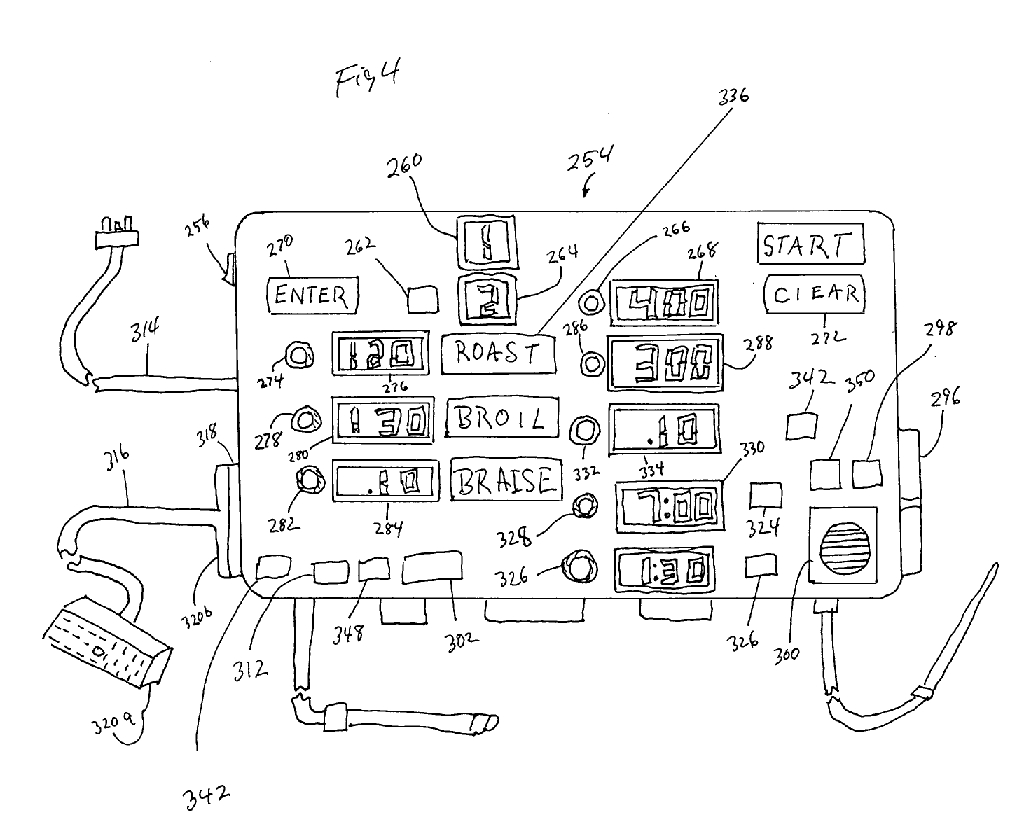

A universal control device and monitor 254 as shown in FIG. 4 includes a power cable, 314, an on/off switch 256, a control cable 316, a control cable socket 318, control cable plugs 320a and 320b. The control device further includes a system type display 260 whereby upon powering up will recognize the type of device and display same. An individual device set key 262 and an individual device display 264 are provided whereby the user is able to set necessary cooking instructions for each device within a multiple device system. These cooking instructions are programmed into the control and monitor device 254 by means of various knobs, displays and keys. An automatic roast set switch 336 is provided allowing the user to perform this task. A roast temperature set knob 266 and its accompanying roast temperature set display 268 provide a standard oven type “bake” temperature setting to be used in conjunction with a thermostat. An enter key 270 and a clear key 272 allow these and subsequent settings to be entered into the memory of the control and monitor device and respectively cleared if so desired. A primary reference temperature set knob 274 and a primary reference temperature display 276 provide means to set the temperature at which and according to the core temperature of a food item, the food item is rapidly provided a substantially ambient temperature environment. An alarm 300 is provided whereby the user is made aware of these and subsequent events. Electrical outlets for ancillary devices 296 are provided whereby the user may automatically energize other devices such as mechanical dial-type microwave ovens, toaster ovens, bread warmers, hot plates or the like at the instant the primary reference temperature is met. An ancillary devices electrical outlets enable/disable switch 298 is provided. A secondary reference temperature set knob 278 and a secondary reference temperature display 280 are provided whereby the user is able to record into memory a secondary reference temperature into the control device whereby the user is alerted to the temperature equalization of the food item cooked thereby. An adiabatic cycle may also be set using the adiabatic cycle duration set knob 282 in conjunction with the adiabatic cycle duration display 284 which provide back-up in the event that the maximum temperature following the temperature equalization falls short of the secondary reference temperature as set by the user.

Referring still to the universal control device and monitor 254, an automatic broil then roast set switch 338 is provided whereby the user may select to broil then sequentially roast a food item when used in conjunction with those embodiments of the present invention that utilize separate broil and “bake” heat sources. The duration of the broil cycle is determined by the surface temperature as monitored by infrared thermometers in the devices that utilize them. A surface temperature set knob 286 is provided in conjunction with a surface temperature set display 288 whereby the user may adjust and set this parameter.

Using the universal control device and monitor 254 with devices capable of holding food in a refrigerated state until a desired service time, if desired, the user engages the service time set switch 324, rotates the service time set knob 328 until the desired service time appears on the service time set display 330 then enters into memory with the enter key 270. The clock set key 326 allows the user to the set the internal clock to the current time. When the user presses the clock set key 326 the service time display 330 flashes thereby and the current time is entered using the enter key to set the current time. Estimated total cook time is entered using the estimated total cook time set knob 332 as displayed on the estimated total cook time display 334. Estimated cook times are determined by standard minutes per pound at specified temperature charts which are well known in the art, with pre-heat times added to bring the affecting environment to the preset roast temperature.

Referring still to the universal control and monitor there is provided electrical outlets for ancillary devices 296 that are capable of energizing other cooking devices. An ancillary devices electrical outlets enable/disable switch allows the use to automatically energize these ancillary devices at the moment the primary reference temperature is met. These outlets would automatically de-energize concurrent with the completion of the adiabatic cycle. There is further provided an ancillary device start time key 350 when the user desires to energize other devices independent of the primary reference temperature event. Since the temperature equalization can take thirty minutes or even longer for large roasts this option would be necessary.

The automatic braise switch 344 allows the user to cook a meat item, contained in a vessel in which the meat item has been at least partially submerged in an aqueous solution, to a desired degree of collagen disintegration, making it more tender.

Referring still to the universal control device and monitor, an adiabatic cycle override/reset switch 302 is provided whereby and in conjunction with embodiments that utilize transport or shield mechanisms, the user may transport or shield the food item to a non cooking configuration as necessary to load, unload, baste, season or perform other such tasks on the food item and return the item to its former cooking configuration. The temperature probe control device input socket 346 allows for the use of the universal control device and monitor 254 as a monitor-only device in cooperation with known cooking situations such as conventional ovens, deep fat fryers, surface burner heated vessels, barbecue grills etc. A phone jack 304 and computer port 306 are provided and allow for remote programming of the universal control device and monitor 254. A wireless device port 308 also provides for data entry, data retrieval and optionally wireless control of the cooking devices and indicators. A barcode reader 310 is provided to the control device and could allow for the scanning of packaged foods or complete meals in order to program the operation of the various embodiments of the present invention. The barcode reader 310 is activated with the barcode reader on/off switch 312. Once all the instructions have been programmed into the control device the start key 294 is depressed.

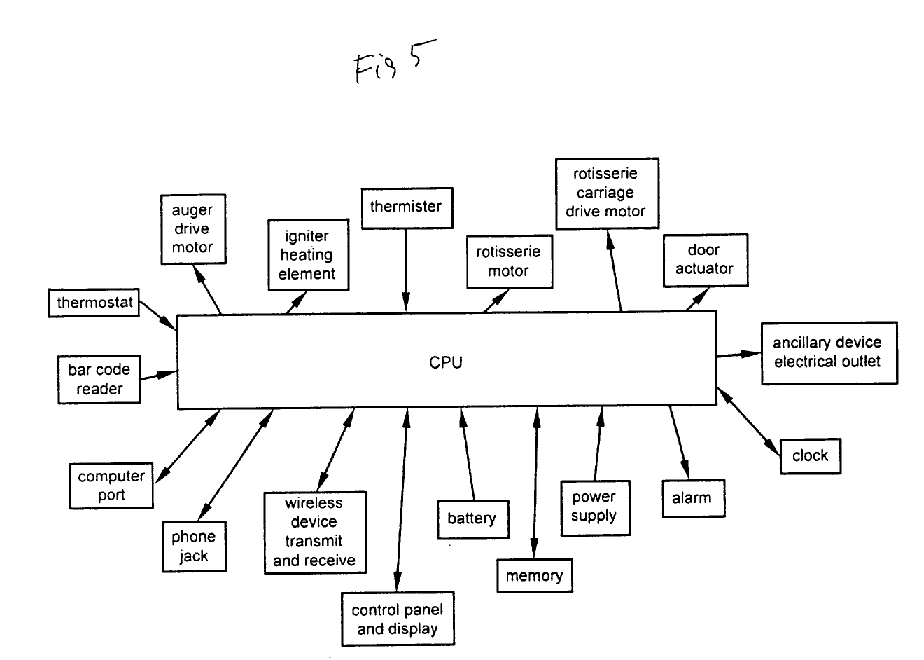

FIG. 5 shows a block diagram schematic of the universal monitor/control device when used with the automatic wood pellet rotisserie carriage cooking device.

Operation of the automatic wood pellet rotisserie carriage cooking device.

Referring to FIGS. 1 and 4, in operation, the automatic wood pellet rotisserie carriage device 30, is connected to electrical service by means of the power cord 40 and to the universal control device and monitor 254 with the control cable. The hopper of the hopper section 36 is supplied through the hopper door 96 with preferable food grade hard wood pellets or charcoal pellets. The material difference between wood and charcoal pellets is the amount of infrared heat given off by the burning of either. Wood pellets give off more flame and as a result produce more infrared heat which is necessary to brown medium sized poultry and small meat items; whereas large roasts and turkeys, who's surfaces would burn from extended heat thereby, benefit from slower less radiant heat as produced by charcoal fire.

When connected to the cooking device the control device 254 is programmed after powering up. Recognizing this single device, single function system causes the roast temperature display 268 to flash indicating a default setting of preferably 400 degrees. The user may elect to change the roast temperature by rotating the roast temperature set knob 266 to a different setting. The roast temperature is entered by depressing the enter key 270 whereby this data is entered into memory and sequentially the primary reference temperature display 276 flashes prompting the user to enter this setting. The user then rotates the primary reference temperature knob 274 as indicated by the primary reference temperature display 276 to the desired setting and enters this setting using the enter key 270, whereby this setting is programmed and the secondary reference temperature display 280 is caused to flash. Rotating the secondary reference temperature set knob 278 to the desired temperature as indicated by the secondary reference temperature display 280 the user then enters this setting into memory by pressing the enter key. An adiabatic cycle duration is set in the same manner using the adiabatic cycle duration set knob 282 used in conjunction with the adiabatic cycle duration display 284. Other electrically powered cooking devices may be automatically energized by using the electrical outlets for ancillary devices 296 as enabled by the ancillary devices electrical outlets enable/disable switch 298.

To place food into the automatic wood pellet rotisserie carriage cooking device 30, the adiabatic cycle override/reset switch and display 302 is pressed whereby the switch is illuminated and the food support and drip pan assembly 68 is ejected from the device to the load/unload position whereupon the food item is placed on the food support grate 70 or suspended from the food support hook 72. There is provided a rotisserie motor override key 348 which may be used to override any given state of the rotisserie motor. After inserting the temperature probe assembly 74 tip into the food item at or near the center of the food item, the start key 294 is then pressed returning the food support and drip pan assembly 68 to a cook position and energizing the rotisserie motor 60. Wood pellets are deposited, if necessary, onto the fire grate 86 as a result of the auger drive motor 78 being energized by the control device. The pellets are forced by means of the solid combustible auger assembly 76 through the solid combustible nozzle 80, down the solid combustible chute 82, and onto the fire grate 86. The electric heating element 84 is then energized sufficient to cause combustion of the wood pellets and sequentially de-energized once combustion has been achieved this step may be effected using the thermostat 88 in much the same was as for gas ovens, providing fuel as necessary. Alternately gas pilot flames may also be used when lighting the fire. The temperature within the cooking device is maintained by the control device in response to the thermostat 88 by dispensing solid combustibles onto the fire grate as needed. Ashes resulting from the burning of the wood pellets fall in to the ash drawer 90. Oxygen needed for combustion enters the device through air vents 98 disposed above the ash drawer.

When the primary reference temperature has been met according to the internal temperature indicated by the temperature probe assembly 74 the food item is evacuated from the cooking device 30 to the load/unload position and the alarm sounds briefly to indicate this event, simultaneously the electrical outlets for ancillary devices 296 are energized if so enabled. Temperature equalization and thus final degree of doneness of the food item is indicated by the alarm 300 once the core temperature of the food item has reached the secondary reference temperature as set by the control device as communicated by the temperature probe assembly 74. As a back up to the secondary reference temperature system there is provided an adiabatic time duration setting whereby a count down timer is started once the primary reference temperature has been met, this setting having been set using the control device 254. The alarm of the control device defaults to a first event priority regarding the adiabatic stage of cooking. Once either event occurs the alarm sounds alerting the user to remove the food from the food support and drip pan assembly 68. Concurrent with the alarm sounding the electrical outlets for ancillary devices, if energized, are de-energized.

### Description of an Alternate Embodiment of the Present Invention

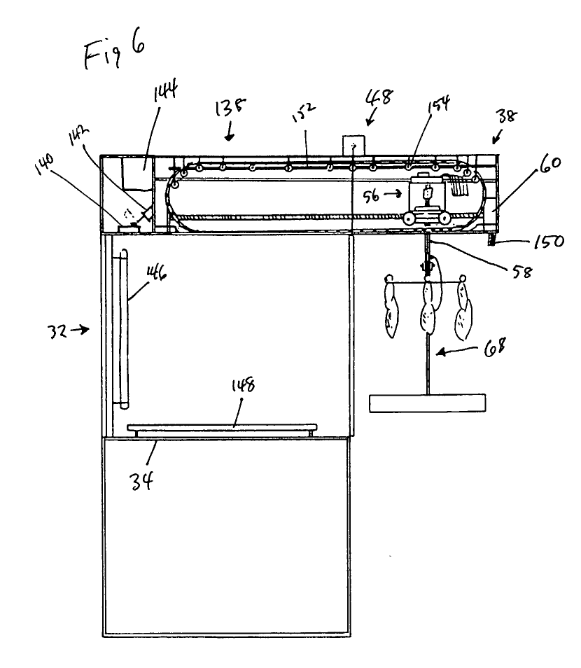

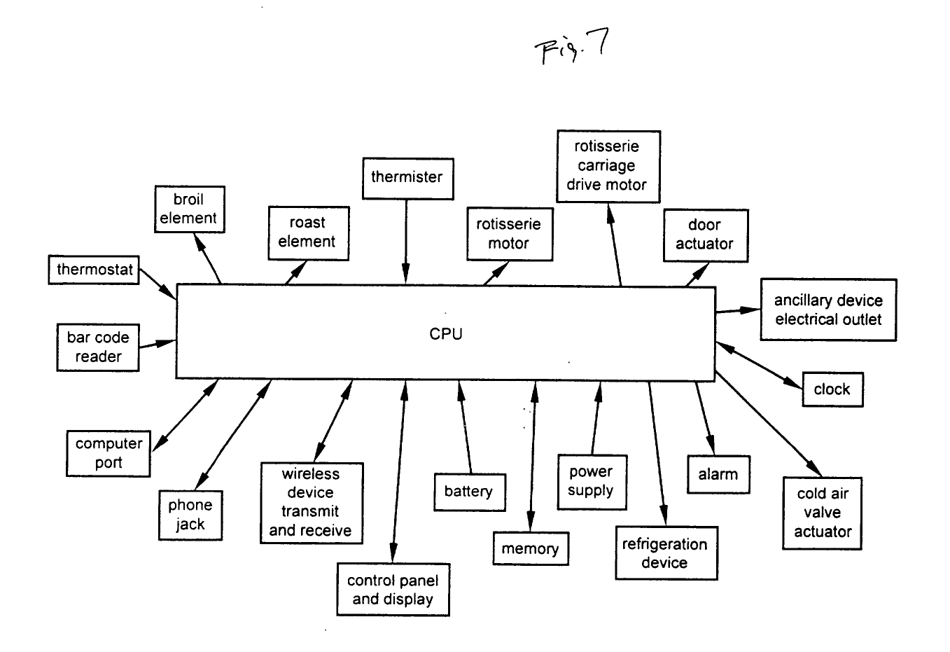

FIG. 6 shows an automatic rotisserie carriage cooking device with hold-till-cook refrigeration system 138. One difference in this device and the wood pellet rotisserie device is the addition of a refrigeration device 144, a cold air valve 140 which is opened by means of a cold air valve actuator 142 allowing for passage of cold air into the cooking section 34 as necessary to maintain a safe environment for the food item pending future cooking. There is also disposed two separate electrically resistive heating elements capable of performing separate broil or roast cycles. There is disposed a broil element 146 and a roast/bake element 148 disposed at the rear and base of the cooking section respectively thereupon. This alternate embodiment further includes a slot cover belt 152 supported by slot cover belt rollers 154 attached to cross members spanning the upper frame members of the transport section 38. This belt is a tank-tread like device that covers the slot 52 much like the slot covers as shown in the previous embodiment and likewise resists the passage of heat therethrough. Though not shown the food support receiver shaft passes through and is secured by a flange type bearing mounted to one of the tank tread-like treads. This embodiment further includes an infrared thermometer 150, which is disposed at or near the center of the leading bottom surface of cantilevered portion of the transport section 38. The infrared thermometer is able to monitor the surface temperature of a food item, which maintains a central axis position within the cooking section 32, and communicates surface temperature as gathered through the front glass door to the control device 254. For food items which do not maintain a central axis position such as individual chicken leg quarters or halves suspended by a merry-go-round-like configuration, a broil-only setting may be used when the user presses the broil only key 290. In this setting the broil element is energized until the primary reference temperature has been met.

Operation

In operation of the automatic rotisserie carriage cooking device with hold-till-cook refrigeration system 138 the device is connected to the universal control device 254 by means of the cable, plugs, and sockets as previously shown. The controller recognizes this multiple function devise and causes the automatic roast set switch 336, the automatic broil then roast set switch 338, the automatic broil till primary reference temperature reached switch 342, and the automatic braise switch 344 to flash. When choosing the automatic roast set switch 336 the user follows the procedure described as used by the previous device whereby the control device would energize the roast/bake element 148 as the roast heat source. If the user selects the automatic broil till primary reference temperature reached key 342 the preceding entering process would be followed except without the roast temperature setting step. When the broil till primary reference temperature option is selected the broil element 146 is energized and remains so until the primary reference temperature has been reached then the broil element 146 is de-energized and the food item is evacuated. This option would be used for steaks, chops, medium to small poultry, medium to small fish, shrimp, lobster etc. Pressing the automatic broil then roast key 338 causes the surface temperature set display 288 to flash. The surface temperature is set using the surface temperature set knob 286 as displayed by the display 288 and entered. Once the automatic broil settings have been entered into the control device 254 the user then enters the remaining settings as described in the above wood pellet device operation. The broil then roast option would be used with medium sized roasts or large steaks if, however, during the broil cycle the primary reference temperature is met prior to either the desired surface temperature being met, this broil then roast setting would default to the broil only cycle as described above and proceed to the adiabetic cycle.

If the user desires to hold the food item in a safe refrigerated state for a time period in advance of cooking, a hold till cook option may be selected. By pressing the service time set switch 328 after entering the system type causes the service time set display 330 to flash. The user then enters the desired service time by rotating the service time set knob 328 as indicated by the service time set display 330 to the desired time of service and presses the enter key which in turn causes the estimated total cook time display 334 to flash. The user then rotates the estimated total cook time set knob 332 as shown on the estimated total cook time display 334 to the desired estimated total cook time of the food item cooked thereby. These times are known to the art and are set typically in minutes per pound at given roast temperatures or during broiling. Upon entering cooking instructions and pressing the start key when using a specified service time, the food item is transported to the cooking position and the door is closed, if the time between the estimated cook time plus the preheat time and the time at which the start key is pressed as determined by the internal clock of the control device is greater than one hour the refrigeration system is used, whereby the refrigeration device 144 is energized and the cold air valve 140 is opened by means of the cold air valve actuator 142 allowing cold air to enter the device thereby sufficient to reduce the temperature within the cooking device to preferably 38 degrees as monitored by the thermostat. The control device 254 changes this embodiment from a refrigeration mode to a cooking mode when the clock shows a time that is equal to the service time minus the estimated total cook time plus the adiabatic time when added to the preheat time.

An automatic braise option is available to the present invention, whereby the user may cook a temperature probed meat item using a vessel containing an aqueous solution intowhich the meat item may be partially or completely submerged in the vessel. If, after entering the system type, the user presses the automatic braise key 344, there are no other settings necessary. The user would place the vessel containing the aqueous solution and the meat item onto the food support grate and insert the tip of the temperature probe assembly into or near the center of the food item. Pressing the start key transports the food item into the cooking position of the cooking section, closes the front door and energizes the roast element 84 to a default oven setting of 400 degree. In the automatic braise setting the primary reference temperature defaults to 186 degrees. When the core temperature of the meat item reaches this temperature, the roast temperature is automatically reduced to 225 degrees. The adiabatic cycle countdown timer, used in this operation as a cooking timer, is automatically started at a default setting of preferably two hours. The alarm sounds at the conclusion of this time setting and the vessel containing the aqueous solution and the meat item is evacuated from the cooking device.

On this embodiment and others capable of programming a service time it may be desirable to energize the ancillary devices independent of the primary reference temperature event and for this reason an ancillary devices start time dial 350 as shown by the ancillary devices energize time display 352 is provided. If, prior to pressing the start key on the embodiments utilizing a service time capability, the user wishes to energize the ancillary devices independent of the primary reference temperature the user would rotate the ancillary devices energize time knob 350 to the desired time as shown on the ancillary devices energize time display 352 then entered, whereby a time duration subtracted from the service time would provide for the time at which the ancillary devices would be energized. For example if pre-blanched vegetables would heat in ten minutes, this time would be subtracted from the service time and the ancillary device would be energized at service time minus 10 minutes.

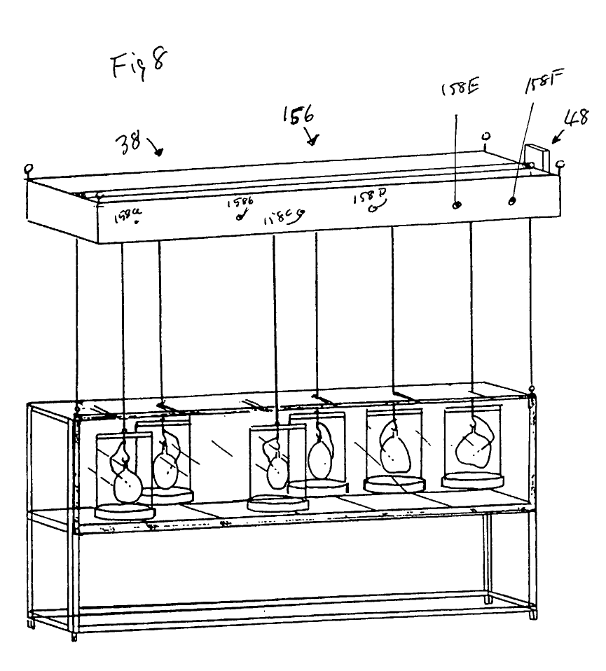

Referring to FIG. 8, another embodiment of the present invention is shown, an automatic rotisserie carriage device with single front door and six rotisserie carriages 156 allows a user to roast continuously, large meat items such as large beef roasts, legs of lamb, turkeys etc. Electrically resistive heating devices, or gas burners capable of producing heat sufficient to maintain preferably 325 degrees, though not shown, would be provided. The transport section 16 would preferably be separate from the cooking section 14 and would be suspended above the cooking section by ceiling supports. With this arrangement it would be possible to place the transport section base even with the ceiling of a restaurant or grocery store.

In operation, the universal control device and monitor 254 having been connected to the six rotisserie device 156, causes the individual device display 264 to flash. The user then selects one of the six available devices on this system type and enters. The user then enters the primary reference temperature, the secondary reference temperature, and the adiabatic cycle duration setting for each meat item cooked thereby, using the adiabatic cycle override/reset switch and display 302 to transport the food support and drip pan assemblies into and out of the cooking section for loading and unloading. Indicator lights 89a, 89b, 89c, 89d, 89e, 89f are provided in conjunction with the alarm to alert the user to the completion of each individual adiabatic cycle.

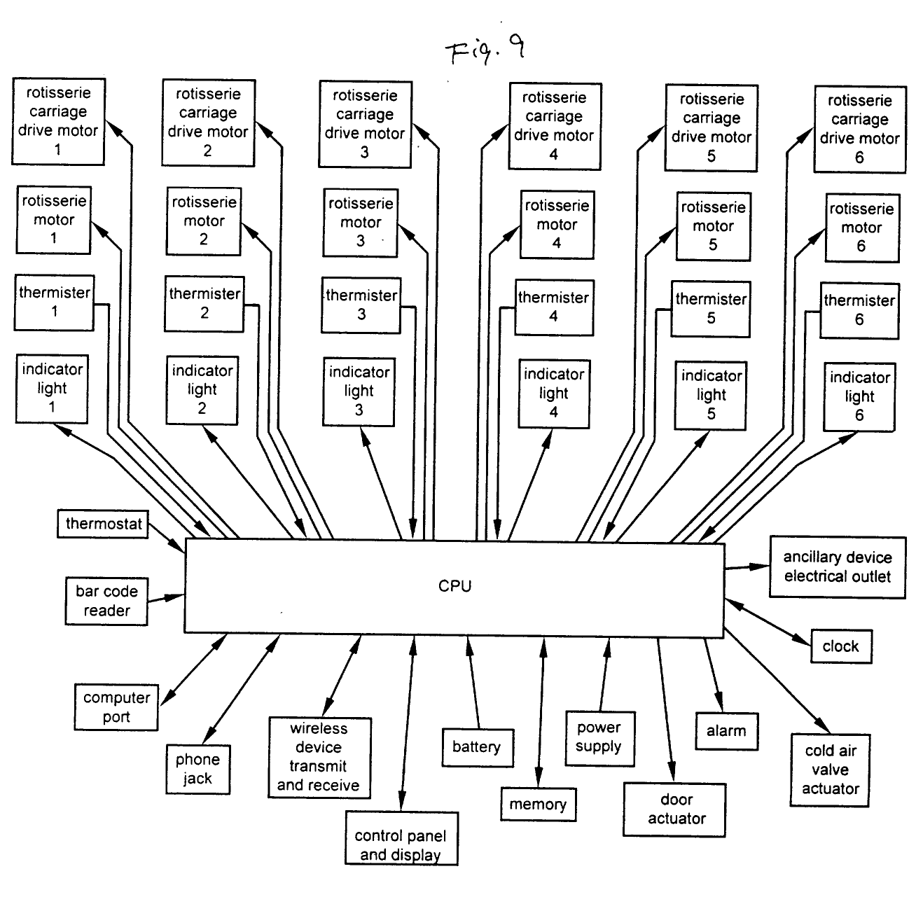

FIG. 9 shows a block diagram schematic of the universal monitor/control device when used with the automatic rotisserie carriage device with single front door and six rotisserie carriages.

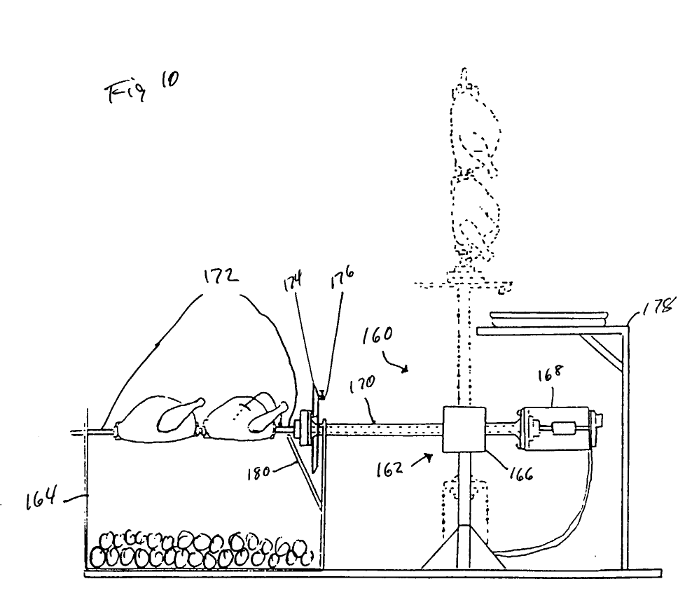

Referring to FIG. 10, an automatically pivoting rotisserie 160 is shown and is comprised of a fire box 164, a actuator assemble 162, a tubular support housing 170, a rotisserie drive assembly 168, and a service shelf structure 178. Attached to the distal end of the tubular support housing 170 opposite the fire box 164 is the rotisserie drive assembly 168. This rotisserie assembly is identical to the rotisserie carriage assembly in the previous embodiments without the wheels. The rotisserie assembly is disposed by means of bolts to a flange on the tubular support housing 170. The distal end of the tubular support housing terminates to a flange mounted bearing. Through this bearing passes a rotisserie drive tube member 172 the distal end of which is secured to an insulated coupling identical to that shown in the rotisserie carriage device. The rotisserie drive tube member 172 supports the food and carries leads to the temperature probe assembly 74 as shown in the previous embodiment. The firebox 164 includes a heat shield 180. The Rotisserie drive tube member 172 further includes drip pan 174 and a drip pan juice valve 176. The actuator assembly 162 is comprised of two vertical members separated by a pivotably disposed cross member which secures the tubular support housing 170. There is disposed on one of the vertical members an actuator 166 capable of rotating the tubular support housing between a horizontal cooking position and a vertical load/unload position.

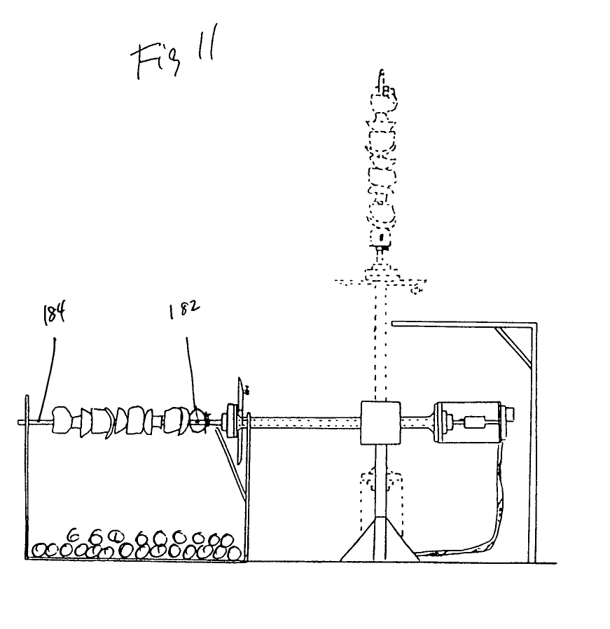

FIG. 11. shows a pivot type device with a thermister skewer 184 whereby shish kebob food items may be cooked automatically. A thermister 182 is preferably embedded into a preferably narrowed rotisserie drive tube member the position of which is indicated on the narrowed rotisserie drive tube with marks on the surface of the rotisserie drive tube skewer 184 which, in this embodiment, serves as a skewer. A food centering collar 186 is provided whereby the user may position a small meat item adjacent the rotisserie drive tube member 184 thermister indicator and adjust and lock the collar with a thumb screw (not shown) whereby correct positioning of the food item on the skewer is guaranteed.

FIG. 12 shows a pivot type rotisserie cooking device with two devices and one fire box. Springably hinged steak clamps 188 are provided whereby a steak, chicken breast, lobster, fish, or quail etc. my be clamped and positioned above the fire box. Though not shown wood and/or charcoal pellet devices would be ideal for this embodiment.

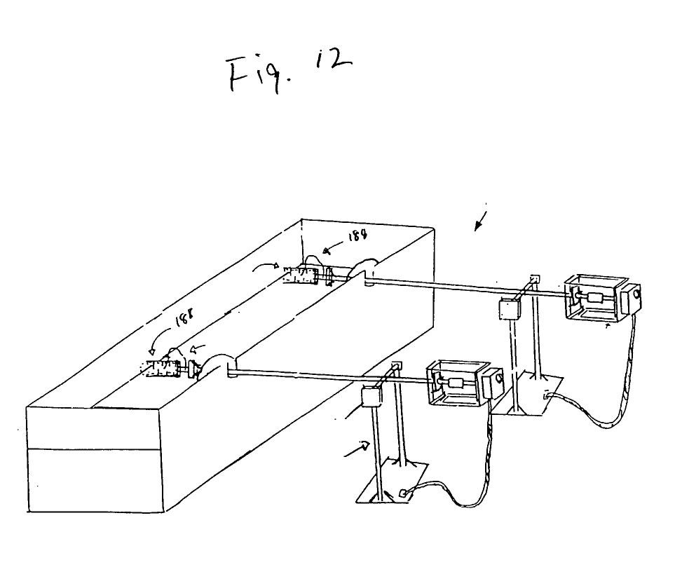

FIG. 13 shows a block diagram schematic of the pivot type rotisserie cooking device when used with the universal monitor/control device.

In operation, the pivot device would respond to the universal control device and monitor 180 in a way similar to that of the wood pellet device 30 in the automatic roast setting. With pivot type devices having a plurality of pivot devices the six rotisserie carriage device operation would provide a model for operation. The adiabatic cycle override/reset switch and display 302 is used to change the position of the pivot irrespective of the cooking cycle as with the carriage devices. The rotisserie motor override key 348 would be used to stop or rotate the rotisserie as needed.

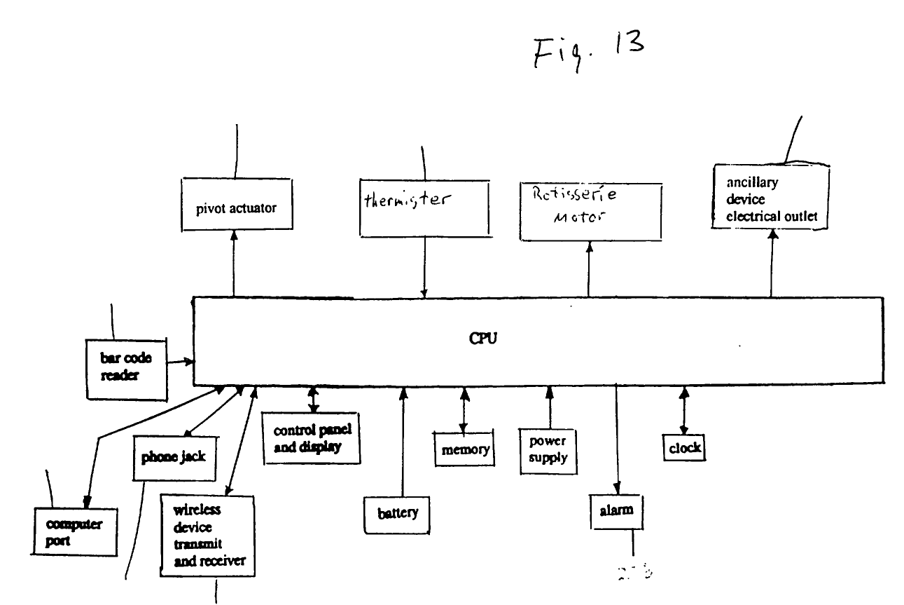

Referring to FIG. 14, an automatically shielded fireplace cooking turntable 190 is shown. This device would be placed in front of a lit fireplace with the intent of automatically cooking a food item thereby as a result of shielding the food item at the instant that a primary reference core temperature has been met, then alerting a user at the completion of an adiabatic cycle. Regarding the automatically shielded fireplace cooking turntable 190, a turntable platform 194 supports a turntable assembly 192. The turntable platform 194 is comprised of a flat, leg supported surface onto which is disposed a turntable rotisserie drive assembly 196 in the center thereof. Pivotably disposed on the turntable output drive tube of the rotisserie drive assembly 196 and supported by the turntable platform 194 is the turntable assembly 192. Along and beneath the outer edge of the rotisserie platform are wheels which allow for support and rotation of the turntable assembly 192 on the turntable platform 194. Disposed onto the turntable platform is a hingeably disposed shield 198 which blocks heat from the fireplace when actuated by the heat shield actuator 200 as controlled by the universal control device and monitor 254. The shield in the load or unload position is provided with heat shield rests 204a and 204b respectively.

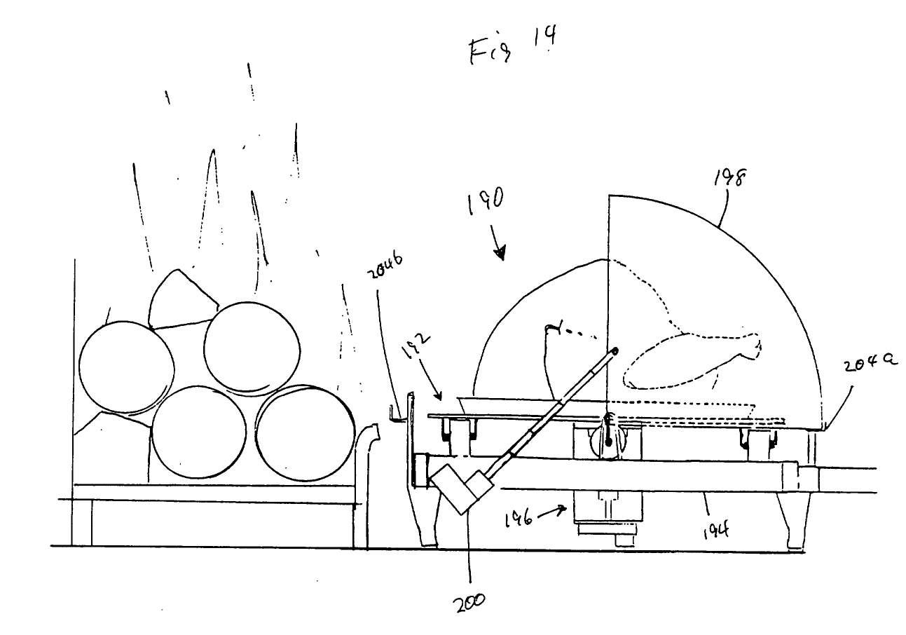

FIG. 15 shows a top view of the cooking device turntable. The temperature probe exits the turntable assembly 192 from the rotisserie drive tube by means of a hinged temperature probe cable storage area cover 206. The user is able to store excess cable in this area. Also shown in the figure is an alternate actuator, a subfractional gear motor 202, shown using hidden lines.

In operation the fireplace turntable device 190 is placed in front of a fire source and connected to the control device 254. Pressing the adiabatic override switch causes the shield to be positioned blocking the heat source allowing for the placement of a food item pan onto the turntable assembly 192. After entering the primary reference temperature, the secondary reference temperature, and the adiabatic cycle duration the start key is pressed whereby the shield is actuated to the cook position allowing for radiant and convection heat to cook the food item. When the primary reference temperature is met the control device energizes the actuator 200 or 202 and shields the food item providing a substantially adiabatic environment thereby. The alarm reacts with this embodiment as with the previous devices. The interior of the fireplace shield would preferably be composed of highly reflective material.

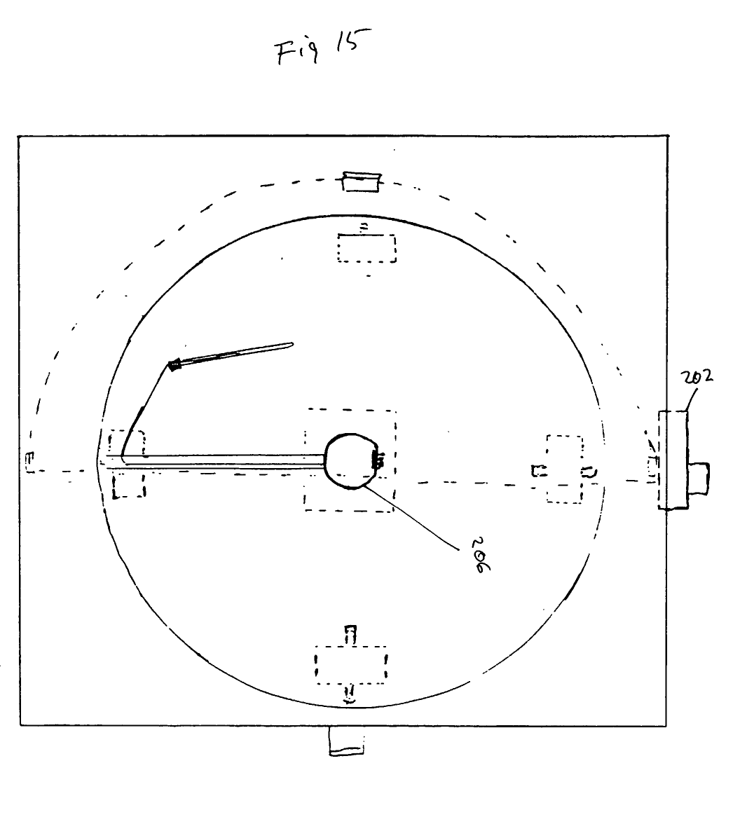

FIG. 16 shows a block diagram schematic of the universal monitor/control device 254 when used with the automatically shielded fireplace turntable cooking device 190.

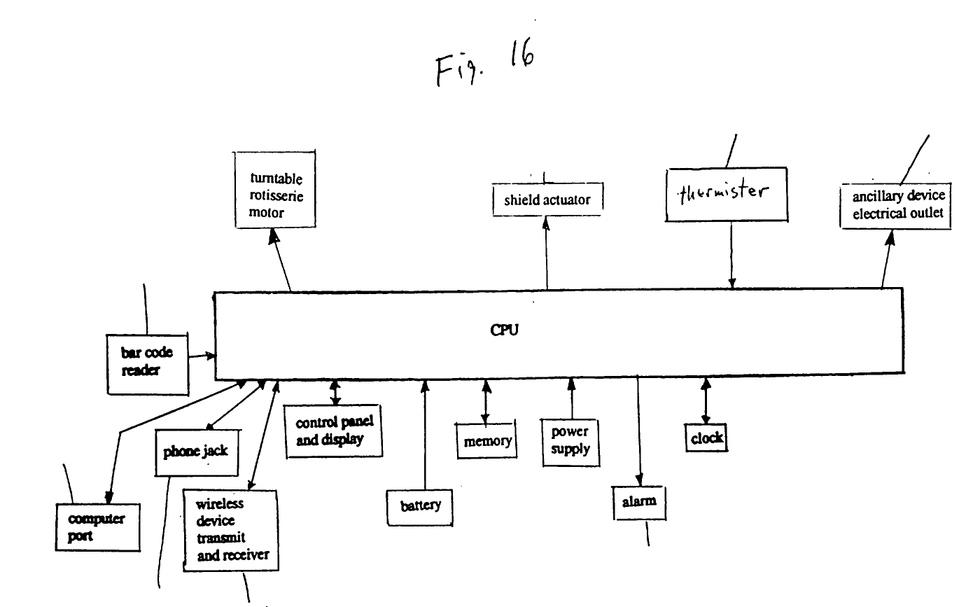

Another embodiment, the chest of automatic cooking drawers 208 is shown in FIG. 17 and is comprised of a rectangular box-like drawer section housing 210 into which are disposed eight drawer accessed cooking ovens 212a, 212b, 212c, 212d, 212e, 212f, 212e, 212g, and 212h on the right side thereof. A plate-warming drawer 216 is disposed on the base of the left side of the drawer section housing 210. Disposed above the plate-warming drawer are a heat and hold drawer 214 and a large automatic cooking drawer 212i. Disposed onto the rear ⅓ upper surface of the drawer housing 210 is a refrigeration device housing 218. Disposed on the upper surface of the refrigeration device housing 218 and cantilevering over the drawer oven housing 210 is an infrared warmer shelf 220 which includes an upper surface and a lower surface. There is disposed onto the lower surface of the infrared warmer structure an electrically resistive infrared warmer 224 the perimeter of which is shown using hidden lines. The infrared warmer 224, when energized, provides radiant heat to served plates when placed on the upper surface of the drawer oven housing. The upper surface of the drawer oven housing provides a plate service area 222.

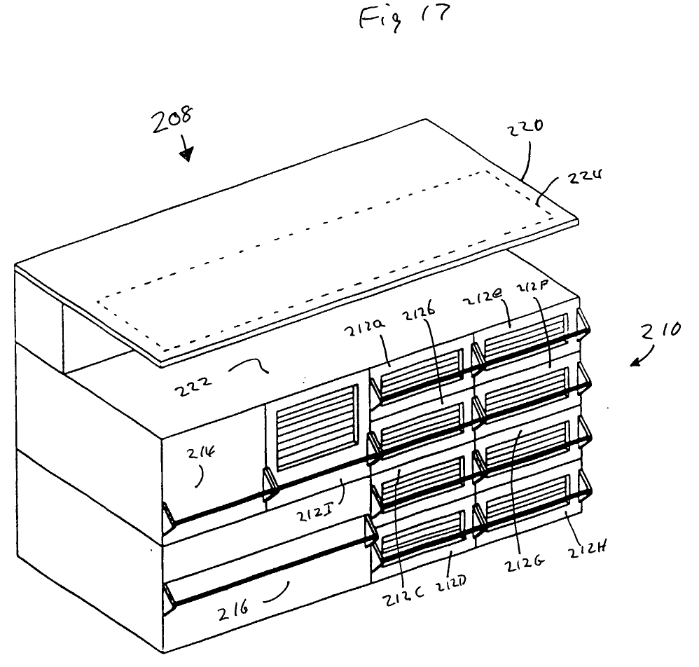

A front elevation of the chest of automatic cooking drawers 208 is shown in FIG. 18. Cooking drawers 212a, 212b, 212c, 212d, 212e, 212f, 212g, 212h, 212I, are shown to have handles and openings blocked by louvers.

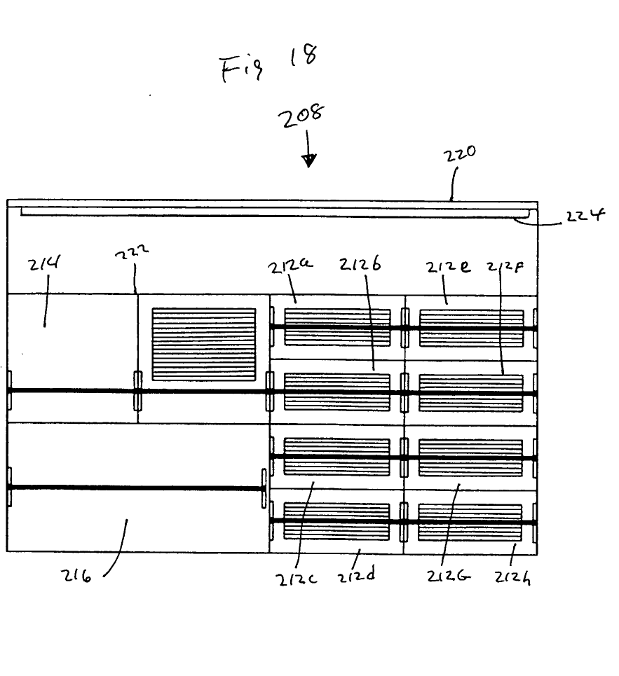

FIGS. 19, 20, and 21 show enlarged left side sectional views of the automatic cooking drawer 212e during the stages of holding, cooking and rapid temperature reduction respectively. The cooking drawer 212e allows the user to place food items into and to remove same from this substantially enclosed oven chamber. Each drawer accessed oven chamber is enclosed and insulated sufficient to heat or chill the interior thereof without substantially affecting the thermal state of adjacent oven interiors. It is preferable that each oven's interior shell be composed of highly thermally transient material such as aluminum allowing for rapid heat exchange thereby. On the floor and ceiling of the oven chamber respectively there are disposed a roast element 225a and a broil element 225b, which provide convection and radiant heat respectively thereby. There is disposed within an opening on the drawer face a louver assembly 228 which allows for the passage of air into the oven chamber. The louver assembly is comprised of a plurality of louvers pivotably disposed within the louver opening and actuated by the louver actuator 226 by means of a tie rod. Within and on the bottom side edge of the cooking drawer face is a magnet 250 which is operably associated with a magnet type proximity switch 252 which is disposed opposite the magnet 250 within and on the base of the oven chamber. Disposed near the leading edge and on the upper surface of the oven chamber is an infrared thermometer 150 for monitoring the surface temperature of a food item being cooked therein.

There are disposed on the back surface of the cooking chamber a cold air valve 234 and an exhaust valve 238 which allow for the passage of chilled air and hot gasses respectively therethrough. The cold air valve opens by means of a cold air actuator 236e into a cold air intake manifold 248a which communicates to a refrigeration system 80 within the refrigeration housing 218. The hot air valve 238 provides an exit means for excessive hot gasses produced during cooking and opens by means of an actuator 240e into an exhaust plenum 242e. The exhaust plenum 242e communicates into a flue 246 through which hot gasses ultimately exhaust. Within the opening to the exhaust plenum is disposed an exhaust fan which when energized provides in concert with the louver system after having been opened, a means by which the temperature of the effective environment within the oven chamber may be rapidly reduced to a substantially ambient temperature environment.

The temperature probe 74 engages with the cooking drawer base my means of a plug and socket (not shown). A drawer electrical socket 230 and a drawer electrical plug 232 provide electrical connection from the temperature probe drawer socket to the device control socket (not shown). The drawer electrical socket also provides electrical connection to the louver actuator 226.

FIG. 19 shows the cooking drawer in a chill configuration using phantom lines to show the cooking drawer in an extended “load/unload” position. The louvers are shown in the shut position and the cold air valve open which allows for the passage of chilled air into the cooking chamber from the energized refrigeration unit 80.

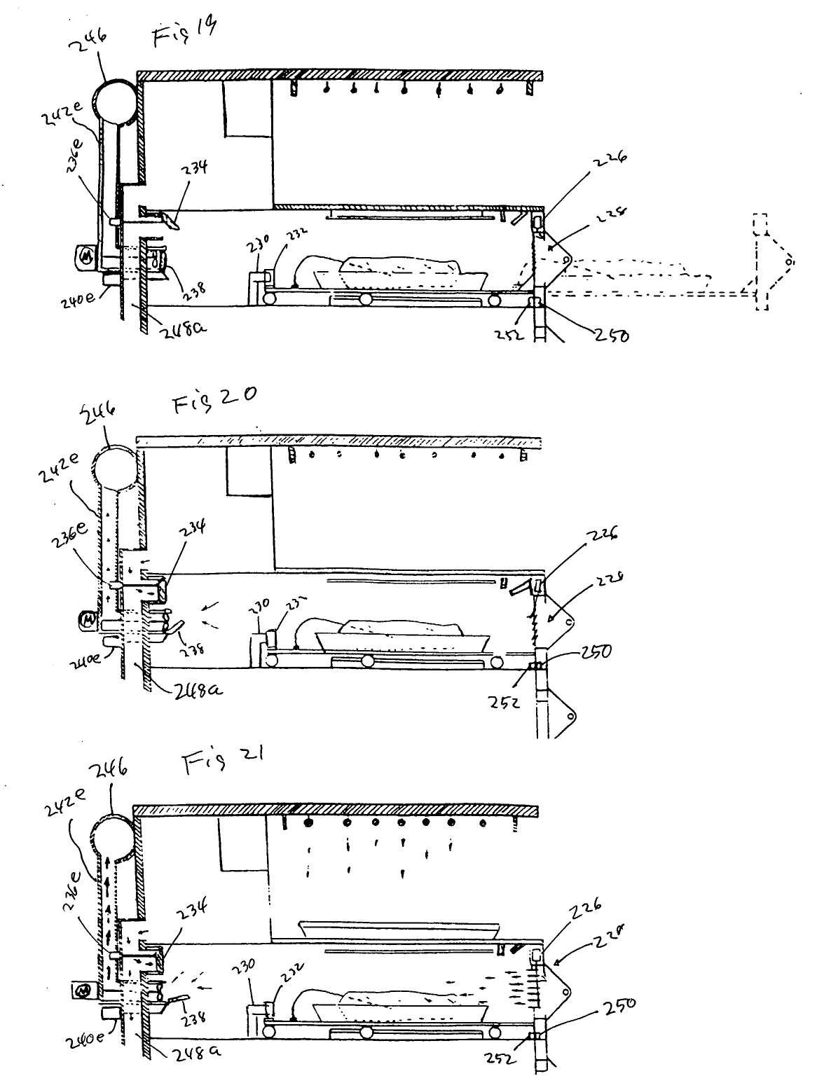

FIG. 20 shows the cooking drawer 142e in a cooking configuration. The louvers are shown in the shut position, the cold air valve is shown in the shut position, and the hot air valve is shown in the open position. In most cooking configuration the exhaust fan would not be energized, however in broiling some small items such as shrimp and especially quail energizing the exhaust fan while broiling could help prevent premature core temperature increases while broiling. With this embodiment the adiabatic override switch would make this possible.

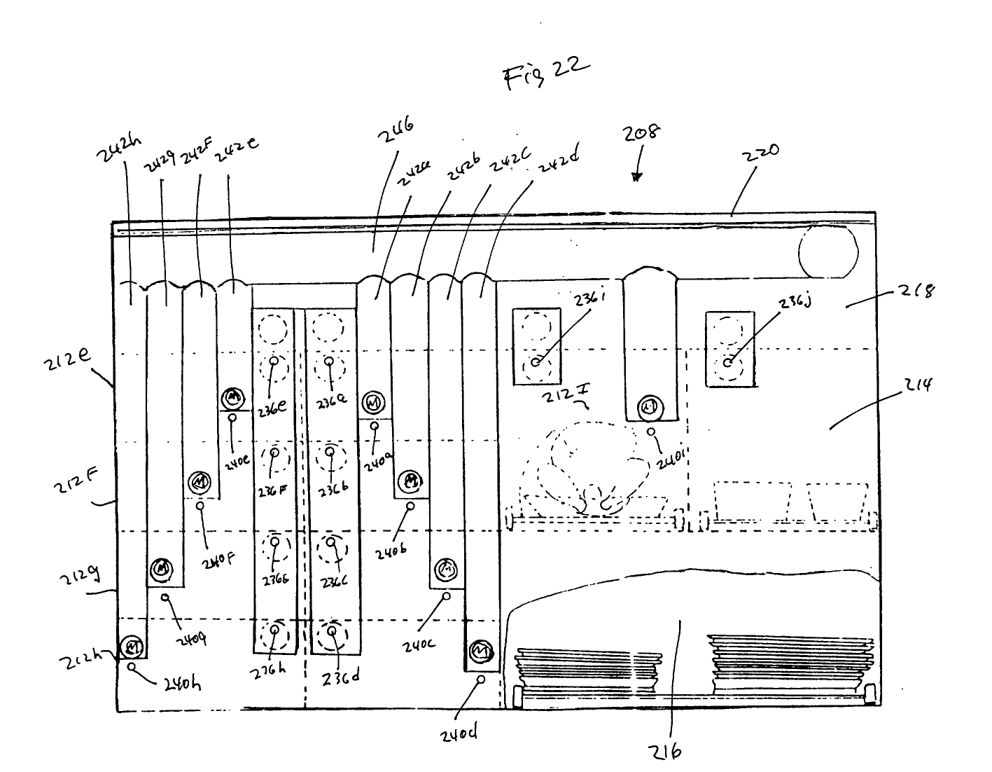

FIG. 21 shows the automatic cooking drawer 212e during a rapid temperature reduction configuration wherein the louvers are open and the hot air valve is open. During a rapid temperature reduction the exhaust fan is energized.

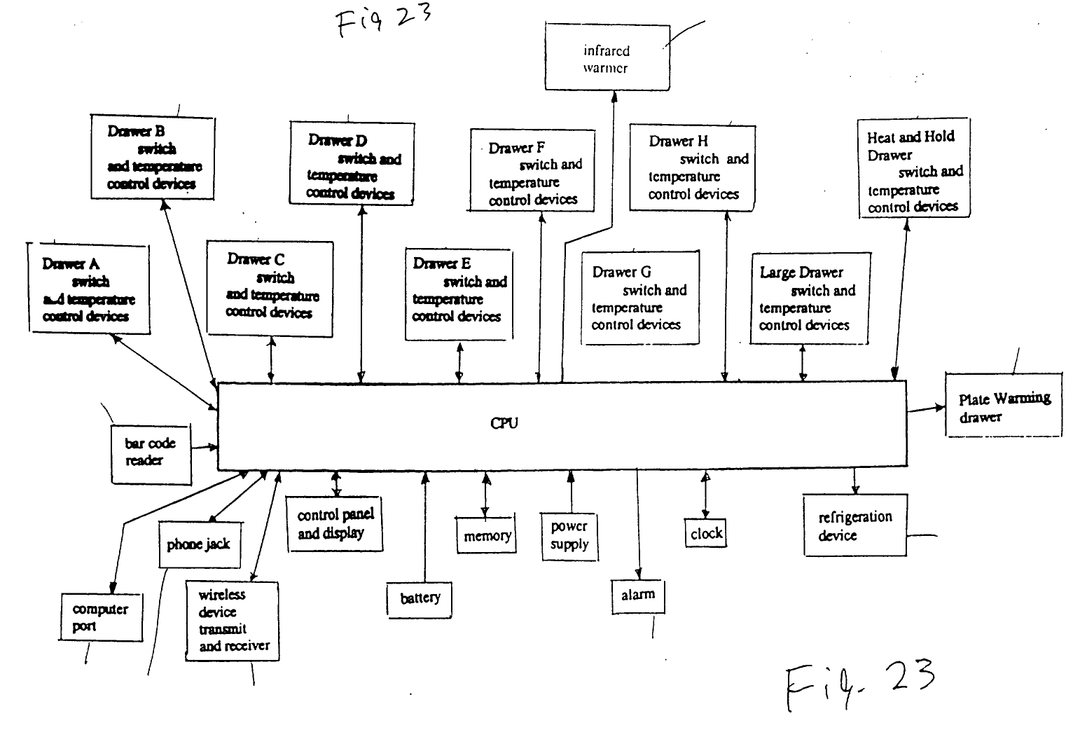

FIG. 22 shows a rear elevation of the chest of automatic cooking drawers 208. Disposed on the back wall are cold air manifolds 248a, 248b, 248c, and 248d. Cold air manifold 248a communicates with the cold air valves of drawers 212e, 212f, 212g, 212h, and the refrigeration housing 218. “Push” type solenoid cold air actuators 236a-j are shown disposed near the distal end of their respective cold air manifolds and urge open and closed their respective cold air valves. The cold air manifold 248b communicates with the cold air valves of drawers 212a, 212b, 212c, 212d, and the refrigeration housing 218. Cold air manifolds 248c and 248d are similarly disposed onto and communicate similarly with the large cooking drawer 212i and the heat and hold drawer 214 respectively. Hot air exhaust plenums 242a, 242b, 242c, 242d, 242e, 242f, 242g, 242h are disposed on the rear of the chest device 208 and provide a means by which hot gasses exit individual cooking drawer oven chambers by way of their exhaust valves and respective motors. Exhaust fan motors are disposed near the distal end of the exhaust plenum and rotate by means of a drive shaft, their respective exhaust fans disposed within the hot air valve. The hot air valve actuators 240a-240e are shown beneath the distal end of the exhaust plenums and are preferably “pull” type solenoids and provide opening and closing force for the hot air valves. The exhaust plenums each connect to the exhaust flue 246, which is disposed on the upper rear surface of the cooking device 208. Plates are shown in FIG. 18, as held in the plate warmer drawer 216, with a partial sectional view. The perimeters of the individual cooking drawer oven chambers as well as the heat and hold and plate warmer drawer chambers are shown using hidden lines. The opening to the cold air valves are shown using hidden lines. A large poultry item and pan are shown using hidden lines within the large automatic cooking drawer 212i. Pans are shown using hidden lines, within the heat and hold drawer 214.

Operation of the Chest of Automatic Cooking Drawers

Referring to FIGS. 12 and 4, in use of the automatic cooking drawer device 208 with the universal control device 254. The user then follows the procedure as shown with the rotisserie carriage device with electrically resistive heating elements and hold-till-cook refrigeration system. The plate warming drawer would be energized at the beginning of any cooking operation. The heat and hold drawer 214 would be energized in accordance with the ancillary devices energizing event as programmed. When programming the heat and hold drawer 214 to energize independent of the primary reference temperature event the user optionally may press the ancillary device start time key 350 which causes the current time display to flash the user may subtract the cooking/heating time of the contents of the heat and hold drawer from the service time. Pressing the enter key enters this data.

It may be preferable instead of using the individual device setting procedure to use drawer “open” or “closed” switching to determine which device is to be programmed. FIG. 15 shows a proximity switch 252 and magnet 250 whereby when the user after having enter the system type and by extending the individual cooking drawer, eliminates the need to select the individual device reducing the risk of error thereby.

FIGS. 19, 20, and 21 show drawer 212e in various stages of cooling, cooking, and evacuation of gasses. In the chill mode, FIG. 19 shows the cold air valve 234 in the open position allowing cold air from the refrigeration device 144 to enter the drawer cooking chamber. FIG. 20 shows drawer 212e in cooking mode; the exhaust valve 238 is shown in the open position this allows for the natural release of expanded gasses during cooking. In normal roasting, the exhaust fan motor would not be energized. FIG. 21 shows cooking drawer 212e during rapid evacuation of hot gasses. During this process the louver actuator is energized, opening the louver assembly 228 by means of the louver actuator 226 and the exhaust fan motor is energized. As with the previous embodiment using electrically resistive heating elements those devices would be de-energized at the point the primary reference temperature is met. The infrared warmer 224 would be energized 5 minutes prior to time of service.

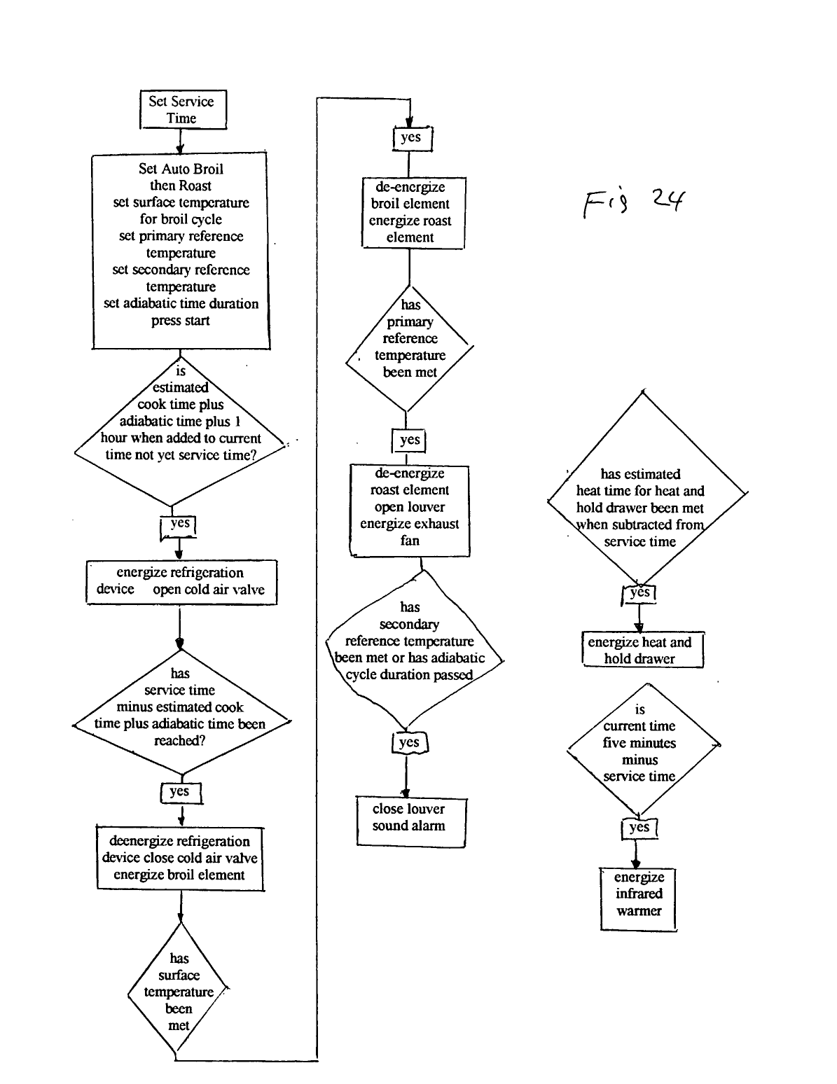

FIG. 23 shows a block diagram schematic of the universal monitor/control device when used with the chest of automatic cooking drawers.

With the chest of automatic cooking drawers it would be possible to order complete meals from a retailer through the Internet, by phone, or in person. Cooking instructions for the chest of cooking drawers could be downloaded through the phone jack 304 as shown in FIG. 4, the computer port 306, or the wireless device port 308. A delivery person could, with access to the customers device, place food having been delivered in cooking containers marked with drawer numbers into their corresponding drawers and leave, all cooking instructions having been programmed remotely including the service time. Sauces and blanched and seasoned vegetables would be placed in the heat and hold drawer 144. Bread would be placed into the plate warmer drawer 146.

Operation of the Universal Monitor/Control Device

When used with other types of cooking situations the universal monitor/control device alerts the user when to provide an ambient temperature environment for a heated food item. The wireless devices port would allow multiple wireless temperature probes to accurately monitor a grilling, roasting, or frying situation in a similar fashion as shown with the preceding embodiments.

Suggested Primary Reference Temperatures.

Primary reference temperatures recommended for the present invention are based largely on meat types with regard to their content of myoglobin. Myoglobin is the muscle equivalent of protein hemoglobin and contains an iron atom which attract and bind with oxygen from the bloodstream. Hemoglobin among other things provides a respiratory transport pigment to myoglobin which provides a respiratory storage pigment for the skeletal muscles and for the heart and diaphragm. When, in animals using this iron based storage system, there is not provided enough oxygen by means of the blood stream reserve or supplemental oxygen is supplied from myoglobin to the mitochondria. Myoglobin provides endurance and bursts of energy to muscles that contain it. Animals who's evolution involved traveling great distances due to migration or to search for food such as cattle, deer, sheep, ducks, gees etc. contain high levels of myoglobin. Aquatic mammals have the largest percentages of myoglobin. A high concentration of myoglobin gives meat a distinctive maroonish red color. Animals that do not heard and/or travel great distances do not typically have high levels of myoglobin. Swine, reptiles and chickens fall into this group. Unweaned calves of beef cattle, also called veal, contain low levels of myoglobin until they are weaned then myoglobin levels rise dramatically due to the increase of iron in their diet. When myoglobin is oxygenated during respiration or exposure to the air it becomes oxymyoglobin and has a bright cherry-red color. Ground beef in bulk will demonstrate bloomed oxmyoglobin on the outer surface while recently exposed interior will not have bloomed and present the darker un-oxygenated color. Completely denatured myoglobin or metmyoglobin looses its redness and takes on a brownish color. During the cooking process myoglobin becomes oxygenated by the action of heat into what I believe is a psudooxymyoglobin, “psudo”, in that it has the cherry red color but is in fact in a heat-induced early stage of denaturing. Rare cooked meat is meat that has been cooked to this psudooxymyoglobin stage and no further. The temperature at which this happens is 120 degrees F. When cooking at an effective environment of say 400 degrees F., a meat item prior to this ultimate temperature must rapidly be provided a substantially reduced temperature environment in order to hit this mark and not go effectively over. Also at 120 degrees tissue albumin coagulates and becomes opaque. A meat item cooked at an ambient temperature environment of 400 degrees must be provided a reduced temperature at a core temperature reading of 110 degrees in order to produce a rare meat item. Latent heat within the mantle of the affected item will carry on to the core thereby producing an even temperature of 120 degrees. Therefor, following are the core temperatures at which and subjected to a 400 degree environment red meat items must be provided with a rapidly reduced temperature environment: rare: 110 F., medium rare: 120 F.; medium: 130; medium well: 140 F.; well done: 150; extremely well done (no trace of pink color): 160. These temperatures would be set as primary reference temperatures in use with the present invention. On average these core temperatures will rise approximately 10-15 degrees during the adiabatic stage provided by the reduced temperature environment. The amount of core temperature increase is, to a large degree, determined by the fat content of the affected item, such that a high fat item, such as heavily marbled beef or sausage, can increase as much as 20-25 degrees due to the caloric capacity of the fat; primary reference temperatures may be adjusted accordingly. The time duration at which temperature equalization occurs is substantially determined by the weight of the affected item. For example, a small steak can achieve temperature equalization in a few minutes whereas a 70 pound steam ship round beef roast can take 45 minutes.

Another phenomenon associated with the cooking of meat is the fact that meat when cooked in a roasting environment develops fluid pressure from the center as the action of heat concentrates fluid within the center. As the heat source is removed from the affected piece this pressure reverses such that while the adiabetic stage is in progress and temperature equalization is transpiring, a period of flux ensues as the moisture restrained within the core returns rapidly to the mantle. Meat cut during this flux stage will “bleed” as a result of this premature cutting and will not at the completion of the adiabatic cycle.

At about 180 degrees the collagen surrounding the cells and forming the connective tissues of meat contract making it very tough, however when subjected to prolonged exposure to heat, just under boiling and within a aqueous dominated environment, collagen disintegrates into liquid gelatin making the meat tender. Depending on the size of meat item, this disintegration will take between 1 to 2 hours.

When cooking using substantially dry heat methods or deep frying white meat items such as pork, veal, turkey, or chicken should be cooked to a primary referenced temperature of 155 degrees for individual portions such as veal steaks or chicken breasts. At 165 degrees the residual hemoglobin in “white meat” food items become colorless. The small amount of myoglobin, for instance in the legs and thighs of chickens and turkeys give those pieces their “dark” color when sufficiently cooked. Whole white meat birds such as turkey or chicken should be heated to a primary referenced core temperature of 165. Cured meats should be cooked to a primary reference core temperature of 145 degrees F. Fish and shellfish should be cooked to a primary reference core temperature of 138 degrees F. Duck breasts can be treated as for beef. Whole ducks should be treated as for white meat birds.

Poaching animal tissue based food using the various embodiments of the present invention would be effected by placing the food item to be poached into a vessel containing an aqueous solution and following the same method as for roasting with the exception that the primary reference temperatures be increased by 8 degrees F. and the adiabatic cycle time be cut in half. When poaching, the secondary reference temperature would remain the same as for roasting.

Deep fried foods when using the monitor device would follow the same method as for roasting assuming the fat temperature to be at or around 375 degrees F.

It should be noted that direct contact type devices such as clamshell type grills with the addition of temperature probes and food evacuation systems would give the same results and the previously described embodiments. Clamshell devices that secured a food in place with a temperature probe inserted and that would by means of actuated clamshells open automatically at a primary reference temperature leaving the food item without contact to either grill surface would produce satisfactory results. Also deep fat fryers with automated basket removal systems when used with temperature probes having been inserted to the core of meat items cooked thereby and connected to a control system as previously described would also provide automatic cooking when used with those types of devices.

1. I claim an automatic cooking device comprising:
a. At least one structure;
b. at least one heat source means capable of cooking a food item;
c. at least one temperature probe means for monitoring the internal temperature of said food item;
d. at least one food support means for supporting said food item within the effective range of said at least one heat source, said at least one food support means engageably associated with at least one of said at least one structure;
e. a monitor and control means operably associated with said at least one temperature probe means, said control means comprising;
a. means for setting a primary reference temperature
b. means for setting an adiabetic cycle said adiabetic cycle being defined as having a beginning point and an end point
c. indicium means responsive to a primary reference being met event and the said end point of the adiabetic cycle.
whereby a user may be alerted to the completion of a preliminary cooking cycle alerting said user to provide an ambient temperature environment for said food item allowing for said adiabetic cycle upon the conclusion of which the user is alerted of this event by said indicium means.

2. The automatic cooking device of claim 1 which further includes:
at least one rapid substitution means for automatically providing a substantially ambient temperature environment for said food item, said rapid substitution means operably associated with said monitor and control means and is engageably associated with at least one of said at least one structure.
